(19) United States
(12) Patent Application Publication
(10) Pub. No.: US 2013/0042494 A1
(43) Pub. Date: Feb. 21, 2013

(54) MULTIDIRECTIONAL AIR DISCHARGE HAND DRYING APPARATUS

(71) Applicant: Chi-Chin HSU, New Tapei City (TW)

(72) Inventor: Chi-Chin HSU, New Tapei City (TW)

(21) Appl. No.: 13/209,951

(22) Filed: Aug. 15, 2011

(51) Int. Cl. F26B 25/06

(52) U.S. Cl. 34/202

(57) ABSTRACT

A multidirectional air discharge hand drying apparatus includes a high-pressure airflow generation device and a casing. The casing has a first opening to receive insertion of user's hands and a hand drying compartment leading to the first opening. The hand drying compartment includes a first wall surface and a second wall surface facing the first wall surface, and at least one third wall surface interposed between the first and second wall surfaces and faced the hand drying compartment. The first and second wall surfaces have at least one first air discharge nozzle. The third wall surface has a second air discharge nozzle. The first and second air discharge nozzles are connected to the high-pressure airflow generation device to eject high pressure airflows with respectively a first output airflow axis and a second air output airflow axis crossed in the hand drying compartment.

### FIELD OF THE INVENTION

The present invention relates to a hand drying apparatus and particularly to a multidirectional air discharge hand drying apparatus.

### BACKGROUND OF THE INVENTION

With people's increasing demand on life quality hygiene also becomes an important issue on people's mind in their daily life, this is especially notable on public lavatory facilities. In the past many public lavatory facilities must be operated manually by users. Continuous progresses have been made these years, for instance sensors have been deployed to detect user's use conditions to make automatic operation possible. Now dedicated paper towels have been provided in many sites to enable users to dry hands after washing without dripping water everywhere. However, with increasing awareness of environmental protection and reservation, tree is seen as a precious resource not to be wasted lightly. As a result, using hand dryers to replace paper towel gradually becomes trendy.

At present there are myriad types of hand dryers on the market. Hand drying mainly adopts a principle of using spinning vanes driven by a motor to suck in air, then the air is heated and ejected to dry user's hands. For instance, R.O.C. patent Nos. M357271 and 579813 disclose a hand dryer that has an air outlet on the exterior to eject air to dry user's hands. They have only one air outlet to eject the air in one direction, hence cannot dry user's hands quickly. Moreover, the covering range of the air outlet is too small and air discharge volume is limited, hence a greater amount of electric power has to be consumed to fully dry the hands.

U.S. Pat. Nos. 7,555,209, 7,657,162 and WO patent 2007/020699 also disclose hand dryers that adopt a different design. They have a hand insertion portion and multiple air outlets at the front and rear sides of the hand insertion portion to form dual-direction air ejection to drive user's palm and backside of hands at the same time. Such a design greatly increases hand drying scope.

While the aforesaid techniques increase hand drying scope by increasing the air outlets and providing dual-direction air ejection to save hand drying time, and offer some improvement over the conventional hand dryer of single outlet and one-direction air ejection, the dual-direction air ejection can blow merely two opposite sides of user's hands but not in an all-around fashion. User's have to move two hands up and down during drying, and even if the palm and backside of the hands have been dried, hand crevices, such as finger gaps and finger nails could still remain wet.

### SUMMARY OF THE INVENTION

The primary object of the present invention is to solve the problem of the conventional hand dryers that provide merely one way or front and rear air ejection and cannot fully dry user's hands and take longer duration to do drying.

To achieve the foregoing object the invention provides a multidirectional air discharge hand drying apparatus which includes a high-pressure airflow generation device and a casing. The casing has a first opening to receive insertion of user's hands and a hand drying compartment leading to the first opening. The hand drying compartment includes a first wall surface and a second wall surface facing the first wall surface, and at least one third wall surface interposed between the first and second wall surfaces and faced the hand drying compartment. The first and second wall surfaces have at least one first air discharge nozzle. The third wall surface has a second air discharge nozzle. The first and second air discharge nozzles are connected to the high-pressure airflow generation device to eject high-pressure airflows. The high-pressure airflows ejected from the first and second air discharge nozzles have respectively a first output airflow axis and a second output airflow axis that cross in the hand drying compartment. The first output airflow axis and second output airflow axis form an included angle greater or smaller than, or equal to 90 degrees.

The multidirectional air discharge hand drying apparatus of the invention can adopt various structures, such as the first, second and third wall surfaces can be connected to each other in a closed manner to surround the hand drying compartment, or form a slot on one of them leading to the hand drying compartment. The third wall surface may also form a first angle with the first wall surface or a second angle with the second wall surface. The first, second or third wall surface may also be formed in an arched surface or a flat surface according to design requirements.

The multidirectional air discharge hand drying apparatus of the invention is adaptable to horizontal or vertical insertion hand dryers. When adopted on the horizontal insertion hand dryers a second opening is provided in the hand drying compartment opposing the first opening to allow user's hands to be extended outwards.

The multidirectional air discharge hand drying apparatus of the invention, in addition to providing one way or front and rear air discharge as the conventional techniques do, further provides high-pressure airflow in other directions to dry user's hands. By providing air discharge in multiple and different directions user's palms can receive the high-pressure airflow in multiple directions so that every portion of the hands can be dried at the same time without being moved constantly, and user's hands can be fully dried in a short time period.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a first embodiment of the multidirectional air discharge hand drying apparatus of the invention.

FIG. 2 is a plane view of the first embodiment of the invention.

FIG. 3 is a plane view of another embodiment of the invention.

FIG. 4 is a plane view of yet another embodiment of the invention with a slot on an annular structure.

FIG. 5 is a plane view of still another embodiment of the invention with a slot on an annular structure.

### DETAILED DESCRIPTION OF THE PREFERRED EMBODIMENTS

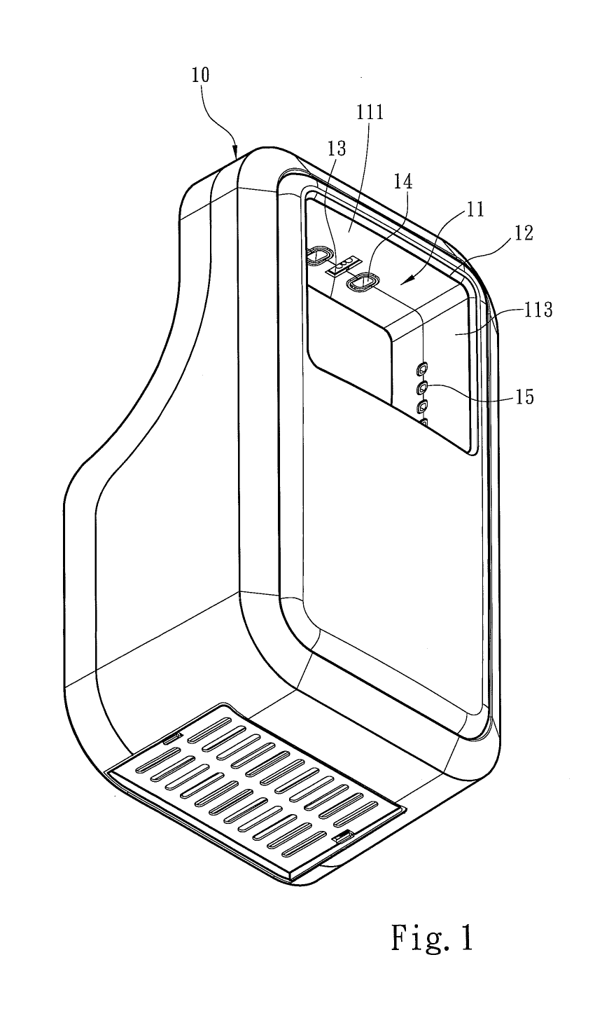

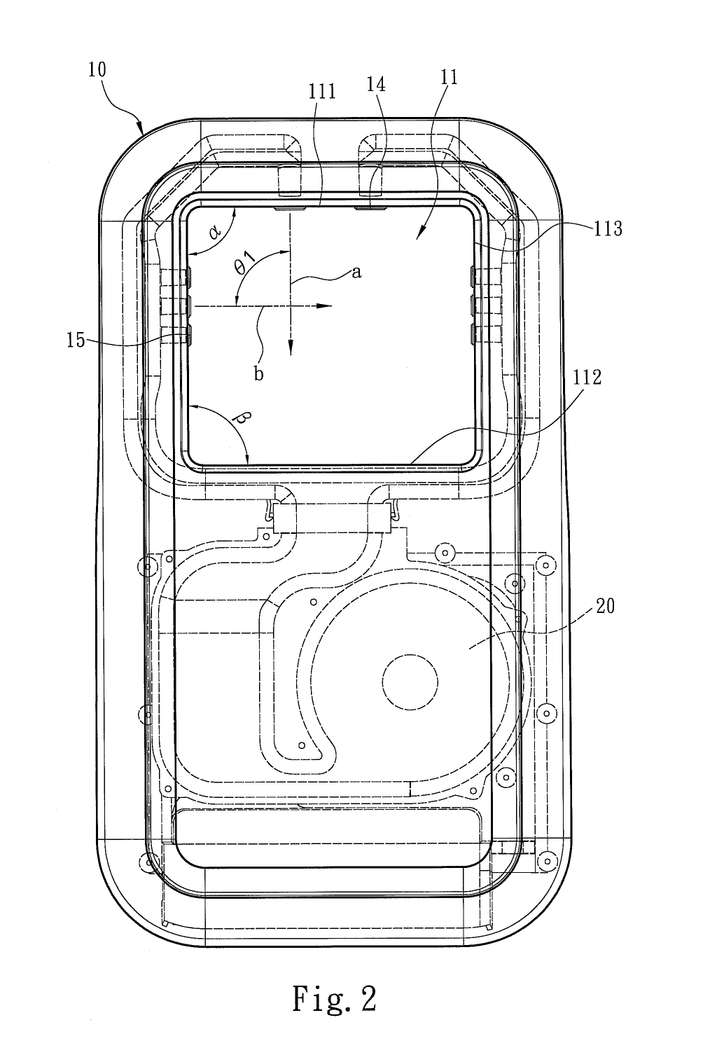

Please refer to FIGS. 1 and 2 for an embodiment of the multidirectional air discharge hand drying apparatus of the invention. It mainly includes a high-pressure airflow generation device 20 to generate high-pressure airflow and a casing 10. The high-pressure airflow generation device 20 can be installed independently outside the casing 10 or inside the casing 10 as the embodiment depicted in the invention. The casing 10 has a first opening 12 to receive insertion of user's hands and a hand drying compartment 11 leading to the first opening 12. The invention is adaptable to horizontal or vertical insertion hand dryers. The embodiment of the invention adopts a horizontal insertion structure. In this embodiment a second opening 13 is provided opposing the first opening 12 to allow user's hands to be extended outwards. The first and second openings 12 and 13 communicate with each other so that user's hands can be moved to and fro in the hand drying compartment 11.

The hand drying compartment 11 includes a first wall surface 111 and a second wall surface 112 facing the first wall surface 111, and at least one third wall surface 113 interposed between the first and second wall surfaces 111 and 112 and faced the hand drying compartment 11. In this embodiment two sets of third wall surfaces 113 are provided at two sides of the first and second wall surfaces 111 and 112. The first wall surface 111 has a first air discharge nozzle 14. The first air discharge nozzle 14 may also be located on the second wall surface 112 as required. The third wall surface 113 has a least one second air discharge nozzle 15. The first and second air discharge nozzles 14 and 15 are connected to the high-pressure airflow generation device 20. The high-pressure airflow generation device 20 can be a blower to generate high-pressure airflow channeled to the first and second air discharge nozzles 14 and 14 through a duct to eject the high-pressure airflow into the hand drying compartment 11. The high-pressure airflows ejected from the first and second air discharge nozzles 14 and 15 have respectively a first output airflow axis a and a second air output airflow axis b that cross in the hand drying compartment 11. In this embodiment the first output airflow axis a and second output airflow axis b form an included angle θ1 equal to 90 degrees.

The hand drying compartment 11 can be formed in a polygon or circle according to design requirements. FIGS. 1 and 2 show that the hand drying compartment 11 of the hand dryer is quadrilateral with the first, second and third wall surfaces 111, 112 and 113 formed in flat surfaces. The first and second wall surfaces 111 and 112 are parallel with each other at the upper and lower sides of the hand drying compartment 11, while the two third wall surfaces 113 are located on the left and right sides of the hand drying compartment 11 to form a first angle α with the first wall surface 11 and a second angle β with the second wall surface 112.

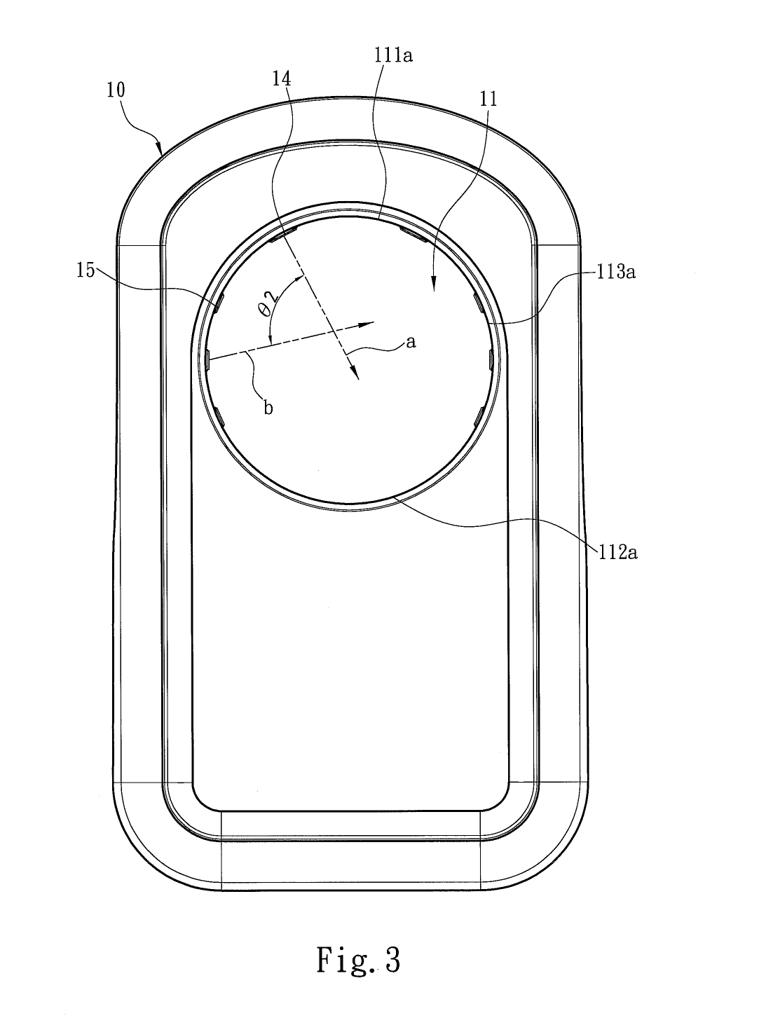

Please refer to FIG. 3 for another embodiment of the invention. It has a circular hand drying compartment 11 with the first wall surface 111a and second wall surface 112a or third wall surface 113a formed respectively in an arched surface and connected to each other to form a closed annular structure. The first output airflow axis a of the first wall surface 111a and the second output airflow axis b of the third wall surface 113a form an included angle θ2 greater and smaller than, or equal to 90 degrees depending on the selected locations of the first and second air discharge nozzles 14 and 15.

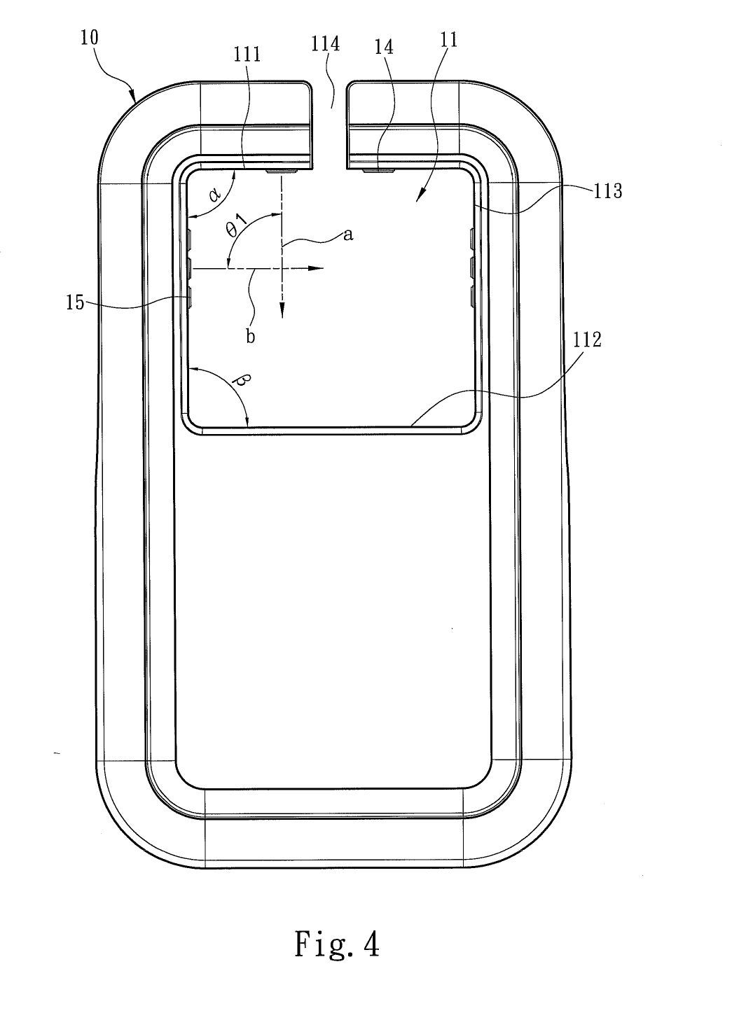

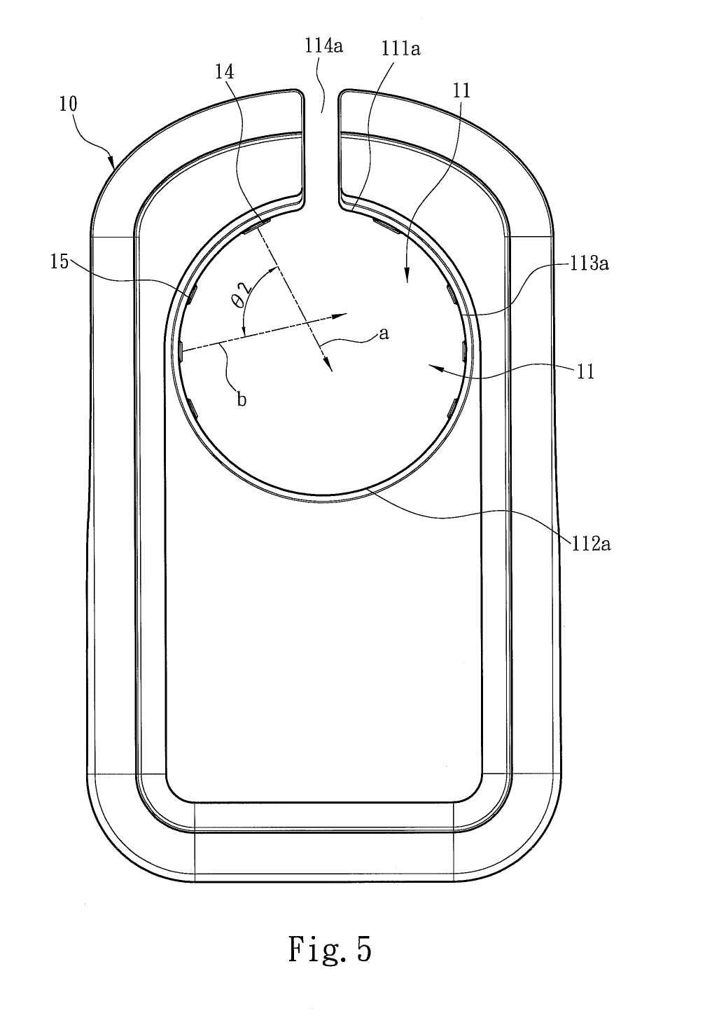

The multidirectional air discharge hand drying apparatus of the invention can also adopt various structures. FIGS. 1, 2 and 3 show the first, second and third wall surfaces 111, 112 and 113 connected to each other in a closed annular manner to surround the hand drying compartment 11. However, this is not the limitation of the invention. FIGS. 4 and 5 show other applicable embodiments in which a slot 114 or 114a is formed on the first wall surface 111 or 111a, second wall surface 112 or 112a, or third wall surface 113 or 113a leading to the hand drying compartment 11 to become an annular structure with a notch formed thereon.

As a conclusion, the multidirectional air discharge hand drying apparatus of the invention has first air discharge nozzles formed on the opposing first and second wall surfaces and also a second air discharge nozzle on the third wall surface facing the hand drying compartment. Hence when user's hands are placed in the hand dryer the palms and backside of the hands can receive high pressure airflow, and other portions and crevices of the hands also can receive the high pressure airflow blowing sideward. As a result, airflow receiving area increases and multidirectional drying effect can be accomplished. Drying efficiency increases and drying quality also improves. It provides a significant improvement over the conventional techniques.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A multidirectional air discharge hand drying apparatus, comprising:
a high-pressure airflow generation device to generate high-pressure airflow; and
a casing which includes a first opening to receive insertion of user's hand and a hand drying compartment leading to the first opening, the hand drying compartment including a first wall surface and a second wall surface facing the first wall surface, and at least one third wall surface interposed between the first and second wall surfaces, the first and second wall surfaces including at least one first air discharge nozzle, the third wall surface including a second air discharge nozzle, the first and second air discharge nozzles ejecting high-pressure airflows which contain respectively a first output airflow axis and a second output airflow axis crossed in the hand drying compartment.

2. The multidirectional air discharge hand drying apparatus of claim 1, wherein the first, second and third wall surfaces are connected to each other to form a closed link surrounding the hand drying compartment.

3. The multidirectional air discharge hand drying apparatus of claim 1, wherein the first, second or third wall surface includes a slot communicating with the hand drying compartment.

4. The multidirectional air discharge hand drying apparatus of claim 1, wherein the first output airflow axis and the second output airflow axis form an included angle greater than or equal to ninety degrees.

5. The multidirectional air discharge hand drying apparatus of claim 1, wherein the first output airflow axis and the second output airflow axis form an included angle smaller than ninety degrees.

6. The multidirectional air discharge hand drying apparatus of claim 1, wherein the first wall surface and the third wall surface form a first angle.

7. The multidirectional air discharge hand drying apparatus of claim 1, wherein the second wall surface and the third wall surface form a second angle.

8. The multidirectional air discharge hand drying apparatus of claim 1, wherein the first wall surface, the second wall surface or the third wall surface is formed in an arched surface.

9. The multidirectional air discharge hand drying apparatus of claim 1, wherein the first wall surface, the second wall surface or the third wall surface is formed in a flat surface.

10. The multidirectional air discharge hand drying apparatus of claim 1, wherein the hand drying compartment includes a second opening opposing the first opening to allow the user's hand to be extended outwards.

11. The multidirectional air discharge hand drying apparatus of claim 1, wherein the high-pressure airflow generation device is located in the casing.
